(19) United States
(12) Patent Application Publication
(10) Pub. No.: US 2020/0235698 A1
(43) Pub. Date: Jul. 23, 2020

(54) TROUGH SHAPED FRESNEL REFLECTOR SOLAR CONCENTRATOR

(71) Applicant: Jeffrey Michael Citron, Tucson, AZ (US)

(72) Inventor: Jeffrey Michael Citron, Tucson, AZ (US)

(21) Appl. No.: 16/842,732

(22) Filed: Apr. 7, 2020

Related U.S. Application Data
(63) Continuation-in-part of application No. 15/909,850, filed on Mar. 1, 2018, now Pat. No. 10,648,700.
Application No. 15/909,850 is a continuation-in-part of application No. 14/162,320, filed on Jan. 23, 2014, now Pat. No. 9,941,436.
Application No. 14/162,320 is a continuation-in-part of application No. 13/337,206, filed on Dec. 26, 2011, now abandoned.
(60) Provisional application No. 61/427,433, filed on Dec. 27, 2010.

(51) Int. Cl. H02S 40/22; F24S 23/70; F24S 10/70; F24S 30/42; H02S 20/32; H02S 40/44; G02B 19/00; G02B 5/09

(52) U.S. Cl. CPC H02S 40/22; F24S 23/80; F24S 10/70; F24S 30/42; H02S 20/32; F24S 2023/872; G02B 19/0019; G02B 19/0042; G02B 5/09; F24S 2010/71; H02S 40/44

(57) ABSTRACT

The present invention is a solar concentrator composed of a generally V-shaped trough of reflective Fresnel steps. The reflective Fresnel steps concentrate the sunlight entering the mouth of the V-shaped trough and parallel to its central axis into a central focal area. By disposing a solar energy receiving element at the central focal area of sunlight concentration, a concentrating solar energy collector is created. Various configurations of solar energy receiving elements are used to convert the concentrated sunlight into other forms of useful energy that can be harvested by the collector.

### CROSS-REFERENCE TO RELATED APPLICATION(S)

The present application is a continuation-in-part of, and claims priority to, U.S. Non-provisional application Ser. No. 15/909,850 filed on Mar. 1, 2018, entitled “TROUGH SHAPED FRESNEL REFLECTOR SOLAR CONCENTRATOR”, which application is a continuation-in-part of, and claims priority to, U.S. Non-provisional application Ser. No. 14/162,320 filed on Jan. 23, 2014, entitled “COMPOUND LINEAR V FRESNEL-PARABOLIC TROUGH SOLAR CONCENTRATOR”, which application is a continuation-in-part of, and claims priority to, U.S. Non-provisional application Ser. No. 13/337,206 filed on Dec. 26, 2011, entitled “TROUGH SHAPED FRESNEL REFLECTOR SOLAR CONCENTRATOR”, which application claims benefit of U.S. Provisional Application No. 61/427,433 filed on Dec. 27, 2010, entitled “TROUGH SHAPED FRESNEL REFLECTOR SOLAR CONCENTRATOR”, the entire disclosures of which are incorporated by reference herein.

### BACKGROUND OF THE INVENTION

### 1. Field of Invention

The present invention is in the field of solar concentrators. More particularly the present invention is shown in the configuration of a solar collector whose purpose is to concentrate solar energy and convert it into other useful forms of energy, although this is not intended to limit its use to that purpose.

### 2. Description of Related Art

Prior art trough shaped concentrators have incorporated complex design elements that make them expensive to manufacture and install in the field. These design elements include curved mirrors that are expensive to make. Other designs include underlying curved geometric configurations of mirrors that require complex support structures. Still other designs show extreme multifaceted mirror configurations. The present invention is designed to simplify design elements, maximize efficiency, and reduce cost of manufacturing.

### SUMMARY OF THE INVENTION

The present invention is a solar energy concentrator that can be readily converted to a solar energy collector. As a solar energy collector, it encompasses the solar energy concentrator of the present invention and a receiving element for receiving the concentrated solar energy and converting it to another form of energy. The present invention is comprised of a solar concentrator made of multiple flat linear, i.e., planar, reflectors, collectively arranged on an underlying support structure, i.e., the trough, to reflect and concentrate the solar energy to an area located on the central line of the trough. More particularly, the reflectors collectively create a Fresnel reflector concentrating the solar energy along the width of the line focal area of the Fresnel reflector. The reflectors are arranged in a step-wise configuration along the underlying V-shaped trough. In an embodiment, a solar energy receiving element is disposed at the line focal area of the trough to transform the solar concentrator to a solar energy collector. In this embodiment, each reflector fully illuminates a width of the receiving element, as viewed from an end of the receiving element. This combination of a generally trough-shaped concentrator having an underlying V-shaped structure with fixed, flat Fresnel reflectors whose axis of concentration is on the center line of the trough-shaped concentrator is itself the new and unique combination of the present invention.

A major advantage of the present invention is that its structural components may be sourced from common off-the-shelf materials. This is due, primarily to the linear nature of the components, making them common and readily available, as opposed to more complex and specially designed components of other concentrators. Another advantage of the present invention, compared to curved trough concentrators, is that its flat linear structure is easily amenable to inexpensive manufacture by being stamped from metallic materials of various gauges. Also, it can easily be installed in a protective housing to shield it from environmental factors such as wind loading and hail. If such a housing is provided with a glazing, the resulting collector will have thermal insulation properties when built as a thermal collector—properties that most parabolic concentrators lack. In such a configuration, commonly available and less expensive tracking mechanisms may be used, compared to those required with parabolic troughs.

In an embodiment, the solar concentrator includes an underlying V-shaped trough; support members extending from the trough; plane reflectors, wherein each reflector is connected to at least one support member; and a solar tracking device. The trough has a first side and a second side that oppose, and are mirror images of, one another, wherein a slope extending from a lowermost edge to an uppermost edge of the first side and the second side, respectively, is constant. At least a front, i.e., inward-facing, edge of each support member is disposed parallel to a central axis of the concentrator, wherein the solar tracking device directs movement of the concentrator such that incoming solar radiation is always parallel to each of the support members. The reflectors are collectively arranged in a stepped architecture along the slope of each side of the trough. This configuration allows the reflectors to reflect and concentrate incoming solar radiation to a central focal area disposed upon the central axis of the concentrator.

In an embodiment, the solar concentrator also includes a solar energy receiving element disposed at the concentrator's central focal area. In an embodiment, as shown in the figures, each reflector illuminates an entire width of the receiving element, as viewed from an end of the receiving element. The receiving element converts the concentrated solar radiation to another form of energy. Depending on the desired effect, when the trough is in an upright position, the receiving element may be positioned lower than, higher than, or in line with the uppermost edge of the trough. Additionally, the receiving element may be constructed in any shape desired. For example, the cross-sectional shape of the receiving element may be circular, rectangular, triangular, hexagonal, etc. Fluid is circulated through the receiving element, whereby the concentrated solar radiation absorbed by the receiving element is converted to heat energy and is transferred to the fluid. Additionally, or alternatively, photovoltaic cells are disposed along the width of the receiving element. The photovoltaic cells convert the concentrated solar radiation into electrical energy. Fluid circulating through the receiving element is used to cool the photovoltaic cells and harvest thermal energy.

Further aspects of the invention will become apparent from consideration of the drawings and the ensuing description of preferred embodiments of the invention. A person skilled in the art will realize that other embodiments of the invention are possible and that the details of the invention can be modified in a number of respects, all without departing from the inventive concept. Thus, the following drawings and description are to be regarded as illustrative in nature and not restrictive.

### BRIEF DESCRIPTION OF THE DRAWINGS

For a more complete understanding of the present invention, the objects and advantages thereof, reference is now made to the ensuing descriptions taken in connection with the accompanying drawings briefly described as follows.

FIGS. 1a and 1b are cross-sectional drawings illustrating the theoretical concept of the present invention;

FIG. 2 shows a cross-sectional representation of the present invention with a higher concentration ratio and two different fabrication methods for the Fresnel reflectors;

FIG. 3 shows a cross-section of the present invention with an alternate solar energy receiving element;

FIG. 4 shows a representation of the present invention as a solar collector with a glazing over the trough;

FIGS. 5a-5d show alternate embodiments of the solar energy receiving element;

FIG. 6 is a perspective view of the present invention; and

FIG. 7 is a cross-sectional representation of one possible tracking mechanism for the present invention.

### DETAILED DESCRIPTION OF PREFERRED EMBODIMENTS

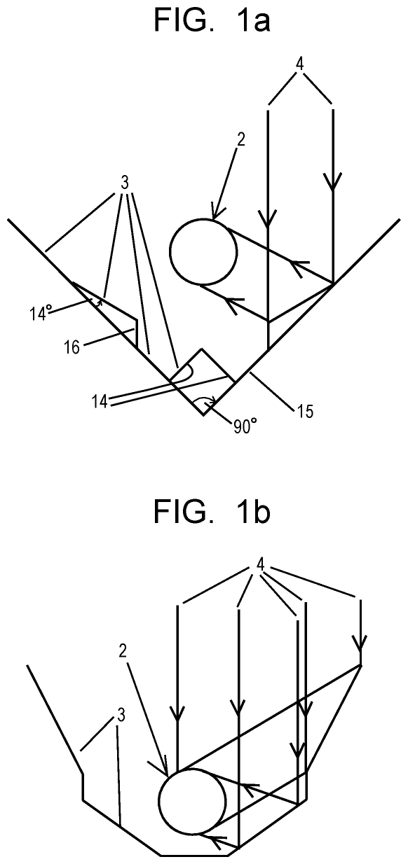

Preferred embodiments of the present invention and their advantages may be understood by referring to FIGS. 1a-7, wherein like reference numerals refer to like elements.

FIGS. 1a and 1b are cross-sectional representations of the basic concept of the present invention designed to illustrate the theory and operation of the invention.

Referring in detail to FIG. 1a, the V shape of the underlying support structure, i.e., the trough 15, is illustrated by the flat, i.e, planar, surfaces. Because each side of the trough 15 is planar, it can be sourced from off-the-shelf materials which will allow for reduction of costs compared to other trough designs that require a support structure adapted to accommodate curved mirrors or a curved underlying geometry. Additionally, the trough 15 is preferably constructed in a lattice-type configuration, which provides a number of benefits, including, but not limited to, weight and cost reduction, modularity, and hence, portability and ease of repair/replacement of parts, and wind force reduction, as air is allowed to pass through gaps disposed between a rear, i.e., outward-facing, edge of one reflector 3 and a front, i.e., inward-facing, edge of an adjacent reflector 3.

Like the trough 15, reflectors 3 are also flat, i.e., planar, making them cheaper to source and manufacture, as compared to curved reflectors used in other trough designs. Support members 16 for each reflector 3 are connected to the trough 15. At least a front edge of each support member 16 is connected to a reflector 3 and is oriented parallel to the central axis of the trough 15. Support members 16 may, but do not need to be reflective. Further, support members 16 may be configured in a number of shapes. For example, support members 16 may be rectangular sheets of material, e.g., metal, whereby each support member has a length that is equal to, or less than, the longitudinal length of the trough 15. In such a configuration, support members 16 are arranged such that one edge is connected to the trough 15 and the opposite edge is connected to a front, i.e., inward-facing, edge of a reflector 3. As another example, support members 16 may be elongated members, e.g., rods/tubes, whereby one end is connected to the trough 15 and the opposite end is connected to the front edge of a reflector 3. As yet another example, support members 16 may be configured with a substantially triangular cross-section, such that support member 16 is wedged, or otherwise disposed, between the trough 15 and the reflector 3. The foregoing examples are for illustrative purposes only, and are not meant to limit the scope of the invention in any way.

As shown in FIG. 1a, a central structure with reflective sides 14 may be used to add stability to the trough 15 but is not necessary, as it may be replaced by stepped reflectors like the other reflectors shown in the figures.

By putting a solar energy receiving element 2 in the focal area along the length of the trough 15, a solar collector is created. The solar energy receiving element is a structural element that is designed to receive and absorb solar energy and convert it to another type of energy. In FIG. 1a the solar energy receiving element 2 is a pipe or tube having a dark or black surface through which a fluid such as water or oil is circulated. The black surface of the receiving element 2 absorbs the solar energy and converts it to heat which is then transferred to the fluid circulating through the receiving element 2.

FIG. 1a shows the path of the light rays 4, shown with vector arrows, that enter the mouth of the concentrator and how they are reflected off the reflectors 3 onto the receiving element 2. Some of these light rays strike the receiving element 2 directly from above. Further consideration of FIG. 1a shows that the angle of inclination of each reflector 3 must be constructed such that the light striking it is reflected onto the receiving element 2. The solar rays 4 and the reflectors 3, off which they are shown reflected, illustrate that each reflector 3 is at least wide enough to fully illuminate the width, of the receiving element 2, as viewed from the end of the receiving element 2.

It is obvious from an examination of FIG. 1 that only direct solar radiation that is parallel to the trough's central axis is reflected onto the receiving element 2 and thus, this concentrator, like most other trough solar concentrators, must track the sun's image across the sky in at least one direction—either in elevation, North/South, or azimuth, East/West. The figures show the angle between the trough sides as 90 degrees but, in fact, the angle may be any angle.

FIG. 1b shows the present invention with the receiving element 2 at a different position in the collector. This is shown to demonstrate that the receiving element 2 is not restricted to any one position. In fact, the receiving element 2 may be positioned anywhere along a line representing a central axis of the trough 15, equal distance from the trough sides. The receiving element 2 may be positioned at the aperture opening of the trough 15, down inside the trough 15 as shown in this drawing or even above the trough opening, i.e., aperture.

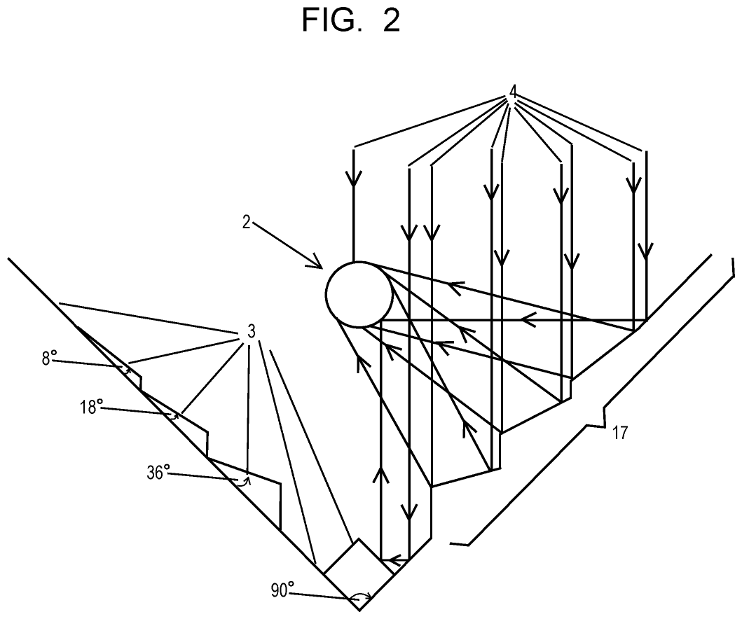

FIG. 2 shows the solar collector in a higher concentration ratio with a wider trough opening, i.e., aperture, and more stepped reflectors 3. Here it can be seen that the angle of inclination of each reflector 3 varies depending on its position on the trough 15. When designing troughs of the present invention the angle and width of each reflector 3 must be determined based on the trough concentration ratio, aperture width, the width of the receiving element 2 and the individual position of the reflector 3 on each side of the trough 15.

The bracketed section 17 shows an alternative construction of the Fresnel trough reflector that lacks the underlying planar support wall. This embodiment could be achieved by stamping it from a highly reflective material of sufficient gauge. Here again, it can be seen that solar radiation strikes the receiving element 2 from the reflectors 3 and from direct solar radiation. Also, it can be seen that the reflected radiation from each reflector 3 fully illuminates the width, of the receiving element 2, as viewed from an end of the receiving element 2.

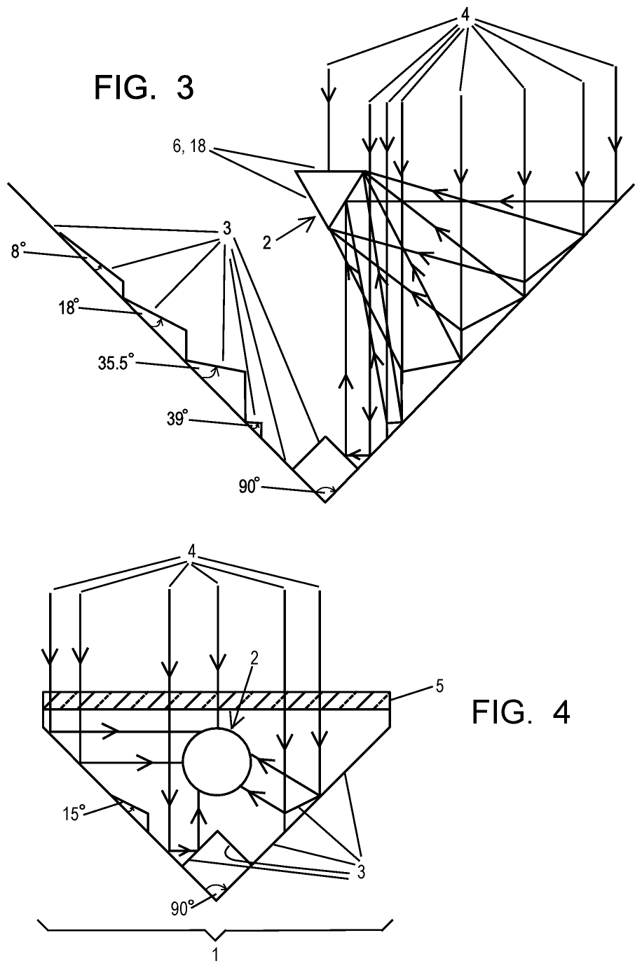

FIG. 3 shows the present invention as a solar collector with a receiving element 2 having an alternative shape. The receiving element 2 illustrated here has the cross-section of an equilateral triangle. The receiving element 2 may be a triangular shaped tube or pipe with a black outer surface that carries a circulating fluid to be heated or it may be a triangular shaped tube that has photovoltaic cells 18 attached to the two underside surfaces or to all three of its outer surfaces 6. If configured with photovoltaic cells 18 on the surfaces of the receiving element 2, the sunlight on the lower two surfaces facing the reflectors 3 is concentrated by the factor of the concentration ratio of the reflectors 3 on each side while the sunlight falling on the upper surface is direct sunlight with a concentration ratio of 1.

FIG. 4 shows the present invention as a solar collector with a glazing 5 covering the mouth of the collector thus enhancing the properties of the present invention as a solar thermal collector designed to convert solar energy into heat in a fluid. The glazing 5 is a structural element that will increase the efficiency of energy conversion by providing thermal insulation retarding the convective loss of heat from the hot receiving element 2 and by trapping the loss of energy by infrared emission from the hot receiving element 2. The glazing 5 may be made of glass or a transparent plastic material. Alternatively, the receiving element 2 could be an evacuated tube, thus eliminating the need for a glazing.

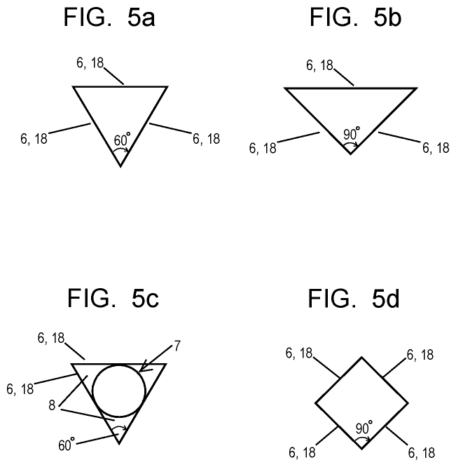

FIGS. 5a-5d show alternative shapes and orientations for the receiving element 2. These alternative shapes may have a heat collecting fluid circulated through them or they may have photovoltaic cells 18 attached to their outer surfaces 6. It is to be noted here that in the event photovoltaic cells 18 are attached to these alternative receiving element 2, a cooling liquid or air may be circulated through them to cool the photovoltaic cells 18.

FIG. 5a shows a receiving element 2 whose cross-section is an equilateral triangle.

FIG. 5b shows a receiving element 2 whose cross-section is a right triangle. This right triangle receiving element 2 is especially suited to match the 90-degree angle of the V-shaped trough 15 as shown in the figures. While only depicted with a 90-degree angle, it should be noted that the present invention is not limited to having an underlying V-shaped trough 15 angle of 90 degrees. Indeed, the concentrator/collector can be made with other underlying V-shaped trough angles without deviating from the scope of the present invention.

FIG. 5c shows a receiving element 2 whose cross-section is an equilateral triangle and on whose sides 6 are mounted photovoltaic cells 18. Inside and concentric with the triangular receiving element 2 is a round tube 7. The round tube 7 is thermally bonded to the triangular receiving element 2 by a heat transfer material 8 so that a cooling fluid can be circulated through the round tube 7 to keep the photovoltaic cells 18 from overheating.

FIG. 5d shows a square tube receiving element 2 with photovoltaic cells 18 mounted thereon. This receiving element 2 would be mounted with its axis from diagonally opposite corners along the trough's central axis. The square tube receiving element 2 has an economic advantage over triangular tube receiving elements 2 in that square tube receiving elements 2 are more easily sourced off-the-shelf.

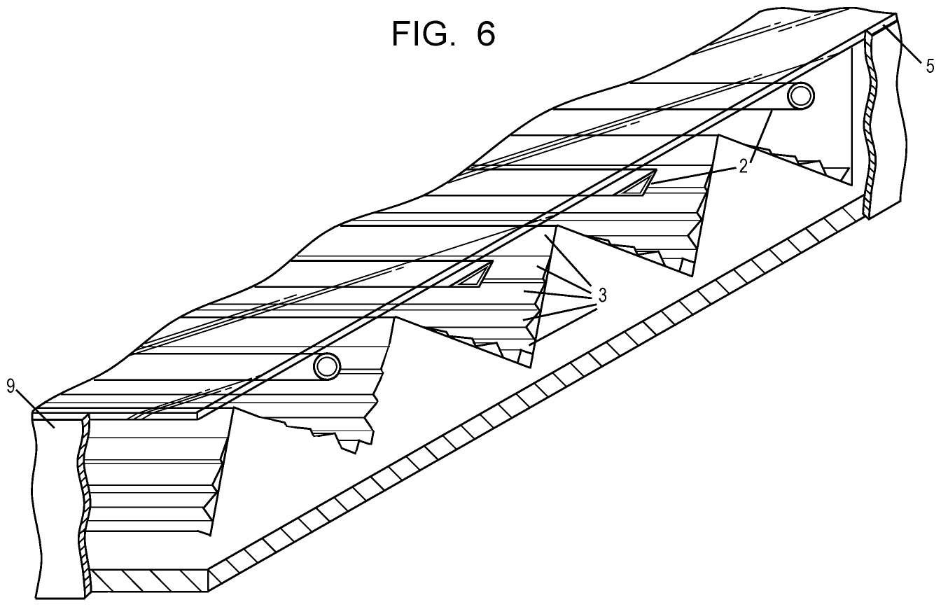

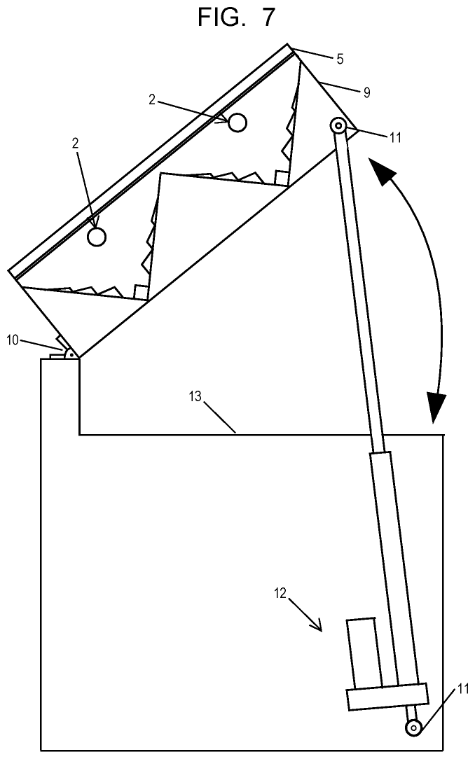

FIG. 6 shows a perspective view of the present invention as a concentrating solar collector showing both round and triangular tube receiving elements 2 and showing the reflective steps 3 of the Fresnel reflector. The collector is depicted within a housing 9 with a glazing 5 covering it.

FIG. 7 shows a simple and inexpensive tracking mechanism that may be used with the present invention as a solar collector. The tracking mechanism consists of a hinge 10 to which the collector housing 9 is mounted and on which it pivots allowing the collector to track the suns motion across the sky in the vertical, North/South, direction. The hinge 10 is also mounted to a base 13 allowing for the needed angle of rotation for the desired hours of solar energy collection. The rotation of the collector is accomplished by a linear actuator 12 which extends and retracts to pivot the collector on the hinge 10. Pivots 11 where the linear actuator attaches to the collector housing 9 and the base 13 allow for the pivoting motion of the collector and the angular motion of the linear actuator that is required to accomplish the tracking of the collector.

The linear actuator in this tracking mechanism must be controlled by a solar aiming device, not here shown, that tracks the vertical motion of the sun across the sky and provides a signal to the linear actuator telling it in which direction to move the collector and how far, thus keeping the axis of the Fresnel concentrator of the present invention pointed at the sun. Solar aiming devices of this type are readily available off-the-shelf devices.

The tracking mechanism herein described is presented for illustrative purposes only and is not the subject of this invention. Other tracking mechanisms commonly known to the state of the art may be used with the present invention.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A solar concentrator comprising:
a. a V-shaped trough;
b. a solar tracking device;
c. a plurality of support members extending from the trough, wherein a front edge of each support member is parallel to a central axis of the concentrator, wherein the solar tracking device directs movement of the concentrator such that incoming solar radiation is always parallel to the front edge of each support member; and
d. a plurality of plane reflectors, wherein at least a front edge of each reflector is connected to at least one support member,
wherein the reflectors reflect and concentrate the incoming solar radiation to a central focal area disposed upon the central axis of the concentrator.

2. The solar concentrator of claim 1, further comprising a solar energy receiving element disposed at the central focal area, wherein each reflector illuminates an entire width of the receiving element, wherein the receiving element converts the concentrated solar radiation to another form of energy.

3. The solar concentrator of claim 2, wherein, when the trough is in an upright position, the receiving element is positioned lower than the uppermost edge of the trough.

4. The solar concentrator of claim 2, wherein, when the trough is in an upright position, the receiving element is positioned higher than the uppermost edge of the trough.

5. The solar concentrator of claim 2, wherein, when the trough is in an upright position, the receiving element is positioned at the same height as the uppermost edge of the trough.

6. The solar concentrator of claim 2, wherein the receiving element has a circular cross-section.

7. The solar concentrator of claim 2, wherein the receiving element has a rectangular cross-section.

8. The solar concentrator of claim 2, wherein the receiving element has a triangular cross-section.

9. The solar concentrator of claim 2, wherein the receiving element comprises a fluid, wherein the fluid is circulated through the receiving element, wherein the concentrated solar radiation is absorbed by the receiving element and converted to heat energy that is transferred to the fluid circulating through the receiving element.

10. The solar concentrator of claim 2, wherein the receiving element comprises photovoltaic cells positioned along the width of the receiving element, wherein the photovoltaic cells convert the concentrated solar radiation into electrical energy.

11. The solar concentrator of claim 10, wherein the receiving element comprises a fluid, wherein the fluid is circulated through the receiving element to cool the photovoltaic cells and harvest thermal energy.

12. The solar concentrator of claim 1, wherein the support members are rectangular sheets of material, wherein each support member has a length that is equal to, or less than, the longitudinal length of the concentrator.

13. The solar concentrator of claim 1, wherein support members are elongated members, whereby a first end of each support member is connected to the trough and a second end is connected to a front edge of a corresponding reflector.

14. The solar concentrator of claim 1, wherein the support members have a substantially triangular cross-section, wherein the support members are configured to be wedged between the trough and a corresponding reflector.

15. The solar concentrator of claim 1, wherein the trough comprises a lattice configuration, and wherein gaps are disposed between a rear edge of each reflector and a front edge of an adjacent reflector, wherein air is allowed to pass through the concentrator in a direction orthogonal to the concentrator's longitudinal axis.
